(19) United States
(12) Patent Application Publication
(10) Pub. No.: US 2025/0385258 A1
(43) Pub. Date: Dec. 18, 2025

(54) ALL-SOLID-STATE BATTERY, ALL-SOLID-STATE BATTERY PACK USING THE SAME, AND METHODS OF MANUFACTURING THEREOF

(71) Applicant: NATIONAL CHENG KUNG UNIVERSITY, Tainan City (TW)

(72) Inventors: Hsing-I HSIANG, Tainan City (TW); Jing-Siang JHAN, Tainan City (TW); Kuan-Cheng CHIANG, Tainan City (TW)

(21) Appl. No.: 18/824,185

(22) Filed: Sep. 4, 2024

(30) Foreign Application Priority Data
Jun. 13, 2024 (TW) 113121805

(51) Int. Cl. H01M 4/58; H01M 4/02; H01M 4/04; H01M 50/505; H01M 50/512

(52) U.S. Cl. CPC H01M 4/5825; H01M 4/0416; H01M 50/505; H01M 50/512; H01M 2004/027; H01M 2004/028

(57) ABSTRACT

One embodiment of the present invention provides a secondary battery which is stable in a high-potential state and/or a high-temperature state. The secondary battery includes a positive electrode and a negative electrode, and either or both of the positive electrode and the negative electrode contains an active material and a composite compound having a crystal structure. The composite compound is used as an adhesive. In addition, the composite compound may be used as an electrolyte. The composite compound having a crystalline structure typically comprises a molecular crystal. In addition, the composite compound having a crystal structure can be obtained by mixing the first compound and the second compound while being heated at a temperature equal to or higher than the temperature at which the mixture melts.

### CROSS-REFERENCE TO RELATED APPLICATIONS

This application claims the benefit of priority of Taiwan Application Number TW113121805, filed 18 Jun. 2024, which is herein incorporated by reference in its entirety.

### TECHNICAL FIELD

The present disclosure relates to an all-solid-state battery, an all-solid-state battery pack using the same, and methods of manufacturing thereof. In particular, the present disclosure relates to an all-solid-state battery positive electrode layer, negative electrode layer, and solid electrolyte layer with phosphates having a NASICON type structure.

### BACKGROUND

The electronic products currently in use commonly use conventional lithium ions batteries with organic flammable electrolytes, which are highly dangerous, and pose problems including spontaneous combustion, spontaneous explosion, environmental contamination as well as the formation of lithium dendrites after charge-discharge cycling for long time.

By contrast, batteries with solid electrolytes, i.e., all-solid-state batteries, may suppress the formation of lithium dendrites. Also, since the solid electrolytes do not contain organic flammable fluids, the potential risk of batteries with liquidous electrolytes including leakage, ignition, or environmental contamination is prevented.

However, the current all-solid-state batteries still have the following drawbacks: low efficiency resulting from the poor contact between the inner electrode layers and solid electrolyte layer, the low efficiency of charging and discharging of batteries resulting from the low conductivity of positive and negative electrodes, and low chemical stability of solid electrolytes and active materials of electrodes.

Accordingly, there is still a great desire for an all-solid-state battery with strengthened contact and lowered resistance and storage loss between interfaces of composite materials, enhanced conductivity and battery performances, and without adverse reactions during charging and discharging.

### SUMMARY

Accordingly, the present disclosure is intended to solve the problems in the prior art including safety concerns in use and environmental contamination resulting from the use of organic flammable electrolytes, high resistance and storage loss resulting from the poor contact between the interfaces of positive and negative electrodes of all-solid-state batteries, and low conductivity and adverse reactions during charging and discharging resulting from inappropriate choice of the types of materials of electrodes and electrolytes.

Accordingly, to solve the problems above, the inventor of the present disclosure conducted extensive research and then provided an all-solid-state battery to solve the problems above. The all-solid-state battery can strengthen contact and lower resistance and storage loss between interfaces of composite materials, enhance conductivity and battery performances, and there is no adverse reaction during charging and discharging for the all-solid-state battery. The present disclosure also provides an all-solid-state battery pack using the all-solid-state battery and methods of manufacturing the battery and the battery pack.

That is, the present disclosure provides an all-solid-state battery, comprising a positive electrode layer containing a phosphate having a NASICON type structure and conductive materials; a negative electrode layer containing a phosphate having a NASICON type structure and conductive materials; and a solid electrolyte layer containing a phosphate having a NASICON type structure. The solid electrolyte layer is deposited between the positive electrode layer and the negative electrode layer, which can be combined to form an all-solid-state battery pack. By containing the phosphates with a NASICON type structure in the positive electrode layer, the negative electrode layer and the solid electrolyte layer, it can effectively strengthen the contact between materials of different layers, significantly lower the resistance between interfaces in the battery, and enhance the battery performances.

In one embodiment, the phosphates having a NASICON type structure of the positive electrode layer, the negative electrode layer, and the solid electrolyte layer are identical materials, i.e., Li₍₁₊ₓ₎M1₍ₓ₎M2₍₂₋ₓ₎(M3O₄)₃, wherein M1 is Al, V, or Cr, M2 is Ti, or Ge, M3 is Si, or P, and x is 0-0.5, for example, when x=0,M2=Ti, and M3=P, Li_{(1+x)M}1₍ₓ₎M2₍₂₋ₓ₎(M3O₄)₃ is lithium titanium phosphate (LiTi₂(PO₄)₃), or when x=0.3, M1=Al, M2=Ti, and M3=P, Li₍₁₊ₓ₎M1₍ₓ₎M2₍₂₋ₓ₎(M3O₄)₃ is Li_{1.3}Al_{0.3}Ti_{1.7}(PO₄)₃. Although the present disclosure only provides the aforementioned examples, x in Li₍₁₊ₓ₎M1₍ₓ₎M2₍₂₋ₓ₎(M3O₄)₃ can be in the range of x=0-0.5. Using identical materials can further prevent the resistance between the interfaces of layers with different materials and the adverse side reactions between the interfaces, thereby enhancing the charging and discharging performances of batteries. In addition, the use of glassy lithium titanium phosphate (LiTi₂(PO₄)₃) helps to reduce the sintering temperature of the all-solid-state battery and increase the density of the green body.

In one embodiment, the positive electrode layer further contains an active material: lithium vanadium phosphate (Li₃V₂(PO₄)₃). The use of lithium vanadium phosphate (Li₃V₂(PO₄)₃), which has the same properties and structure of lithium titanium phosphate (LiTi₂(PO₄)₃) as the phosphate having a NASICON type structure, can effectively strengthen the contact between the positive electrode layer and the solid electrolyte layer, and significantly reduce the resistance between the interfaces, thereby improving the battery performance.

In one embodiment, the negative electrode layer further contains active materials including lithium vanadium phosphate (Li₃V₂(PO₄)₃), lithium titanium phosphate (LiTi₂(PO₄)₃), or metal lithium. The use of lithium vanadium phosphate (Li₃V₂(PO₄)₃), lithium titanium phosphate (LiTi₂(PO₄)₃), or metal lithium, which has the same properties and structure of lithium titanium phosphate (LiTi₂(PO₄)₃) as the phosphate having a NASICON type structure, can effectively strengthen the contact between the negative electrode layer and the solid electrolyte layer and significantly reduce the resistance between the interfaces, thereby improving the battery performance.

In one embodiment, the conductive materials contained in the positive electrode layer and the negative electrode layer include conductive carbon black, activated carbon, or graphite and have an amount of 0.1-10 wt % of the positive electrode layer, and 0.1-10 wt % of the negative electrode layer. Preferably, the conductive material is conductive carbon black, which is added by two ways: one is by enclosing the active material, another is by additionally adding and mixing. Both the positive electrode layer and the negative electrode layer contain 0.1-10 wt % conductive carbon black, preferably 5-10 wt %.

In one embodiment, the active materials have an amount of 50˜99 wt % of the positive electrode layer, and 50˜99 wt % of the negative electrode layer, which can increase the capacity of the all-solid-state battery of the present disclosure.

Also, the present disclosure provides a method of manufacturing the all-solid-state battery, comprising:
Step 1: preparing a positive electrode green body containing a phosphate having a NASICON type structure;
Step 2: preparing a negative electrode green body containing a phosphate having a NASICON type structure or a metal lithium;
Step 3: preparing the solid electrolyte layer containing a phosphate having a NASICON type structure, comprising:
Step 3.1: melting phosphates raw materials having a NASICON type structure at high temperatures, then being quenched into a glassy state, then refined and ground to powders;
Step 3.2: preparing the powders into a green body;
Step 3.3: sintering the green body at 700-1100° C. to an electrolyte sheet having a density of 95% or more;
Step 3.4: placing the positive electrode green body on the sintered electrolyte sheet, and thermally treating them at 700-1100° C.;
Step 3.5: placing the negative electrode green body on the other side of the electrolyte sheet treated with step 3.4, and thermally treating them at 700-1100° C., or using metal lithium sheet as negative electrode. With this method of manufacturing, the solid electrolyte layer can exhibit excellent conductivity.

In one embodiment, the sintered phosphates powders having a NASICON type structure in step 3.3 has 90% or more crystalline and a remaining glass content lower than 10%. The data is the result of X-ray diffraction analysis of glass ceramic powders added with 50 wt % aluminum oxide powders, which represents the crystallinity of phosphate ceramics obtained by refinement analysis with the software GSAS-II and the following equation. Accordingly, in the all-solid-state battery of the present disclosure, the crystalline of the electrolytes results in better ionic conductivity, and the crystalline of the electrode results in better ionic conductivity and electronic conductivity. During the process, the phosphate glass can help to increase the subsequent sintering density of ceramic body.

$$ratio of \text{} remaining \text{} glass = [ 1 - ( wt \% of aluminum oxide powders added / wt \% of aluminum oxide powders refined ) ] / ( 100 - wt \% of aluminum oxide powders added ) \qquad Equation$$

Also, the present disclosure provides an all-solid-state battery pack, comprising:
a metal current collector layer selected from at least one of a group consisting of nickel, copper, silver, and platinum;
a plurality of the all-solid-state batteries.

Accordingly, the battery pack of the present disclosure exhibits excellent electrical performance and stability.

Also, the present disclosure provides a method of manufacturing the all-solid-state battery pack, comprising:
interconnecting the plurality of the all-solid-state batteries in parallel with the metal current collector layer, and collecting to positive electrode and negative electrode at both ends to form the all-solid-state battery pack.

The all-solid-state battery of the present disclosure can replace conventional batteries with organic flammable electrolytes as non-flammable batteries with greater safety in use.

The all-solid-state battery of the present disclosure can prevent the formation of lithium dendrites after a lot of charge-discharge cycles in battery, thereby maintain the stability of the battery.

Furthermore, the lithium ionic conductivity of the all-solid-state batteries in the prior art is lower than that of the conventional batteries with electrolytes. However, the electrode layer and the electrolyte layer of the present disclosure are made of phosphates having a NASICON type structure, thereby effectively strengthen the contact between materials of different layers, significantly lower the resistance between interfaces in the battery.

Further, although the solid batteries in the prior art use electrodes with full-ceramic materials, due to the relatively lower electronic conductivity of ceramic materials, the thicknesses of the electrode layers have to be reduced to lower the resistance. However, the less the thicknesses of the electrode layers, the lower the charging and discharging efficacies and the capacity of batteries. However, the present disclosure adds an appropriate amount of conductive materials such as carbon black into the electrode layers to effectively enhance the electronic conductivity of the glassy materials, thereby ensuring that the electrode layers are thick enough to maintain excellent storage capacity and extremely low resistance in the batteries at the same time, and the batteries exhibit high stability.

If the positive and negative electrodes and electrolyte of the all-solid-state battery of the present disclosure use materials with similar material structure or similar properties, it is beneficial for co-sintering and co-manufacturing the composite materials of battery. There is no reaction leading to the decomposition or phase change of active materials after co-sintering. Also, the positive electrode layer, the negative electrode layer, and the solid electrolyte layer may be manufactured on a production line simultaneously, which can reduce the cost of setting production lines and increase the yield of manufacturing the batteries. Furthermore, the original material properties of the electrodes with identical structure may be maintained after a lot of charge-discharge cycles and the life cycles of batteries may be prolonged. If using incompatible materials as electrolytes and materials of electrodes, adverse side reactions may occur easily at interfaces, which would further affect the charging and discharging performances of batteries. Therefore, the all-solid-state battery of the present disclosure indeed exhibits potential for technical development and business value and may be applied to consumer electronics, emerging wearable electronics such as industry sector of wireless headphones, e-glasses and e-watches, electric cars, etc.

### BRIEF DESCRIPTION OF THE DRAWINGS

FIG. 1 represents the schematic diagram of structure of all-solid-state battery pack of the present disclosure.

FIG. 2 represents the AC impedance analysis spectroscopy of solid electrolyte manufactured by Li_{1.3}Al_{0.3}Ti_{1.7}(PO₄)₃ glass powders.

FIG. 3 represents the AC impedance analysis spectroscopy of solid electrolyte manufactured by Li₃V₂(PO₄)₃ glass powders.

FIG. 4 represents the AC impedance analysis spectroscopy of contacting interface of the crystalline electrode layer and the solid electrolyte layer.

FIG. 5 represents the AC impedance analysis spectroscopy of contacting interface of the glassy electrode layer and the solid electrolyte layer.

FIG. 6 represents the microstructure image of the crystalline electrode layer and the solid electrolyte layer.

FIG. 7 represents the microstructure image of the glassy electrode layer and the solid electrolyte layer.

FIG. 8 represents the charge-discharge voltage curve diagram of the all-solid-state battery pack of the present disclosure after 1-4 cycles.

FIG. 9 represents the cyclic voltammogram of the all-solid-state battery pack of the present disclosure after 100 cycles.

FIG. 10 represents cycling test diagram of the all-solid-state battery pack of the present disclosure after 100 cycles.

### DETAILED DESCRIPTION

The purpose of the present disclosure is to provide an all-solid-state battery, an all-solid-state battery pack using thereof, and methods of manufacturing thereof. The content of the present disclosure will be explained via examples below. The examples of the present disclosure are not intended to limit the present disclosure to be conducted in any specific environment, application or special way as described in the examples. Therefore, the illustration with regards to the examples is only for describing, not for limiting, the present disclosure.

Specifically, although the examples of the present disclosure use Li_{1.3}Al_{0.3}Ti_{1.7}(PO₄)₃ as an exemplary phosphate having a NASICON type structure, the type of the phosphate having a NASICON type structure of the present disclosure does not limit to Li_{1.3}Al_{0.3}Ti_{1.7}(PO₄)₃. Any type of phosphate having a NASICON type structure can effectively strengthen the contact between materials of different layers and significantly lower the resistance between interfaces in the battery, thereby enhancing the battery performances in the present disclosure.

### Example 1: Manufacturing the all-Solid-State Battery, the all-Solid-State Battery Pack

### [Manufacturing the Positive Electrode Layer]

Manufacturing Li₃V₂(PO₄)₃ glass powders:

Ammonium dihydrogen phosphate, vanadium pentoxide, and lithium carbonate were used as raw materials and calcined at 450° C. to remove volatile substances and form glass precursor. The glass precursor was melted at 1000° C., then poured on a stainless-steel plate, and then quenched into glassy state. Then, the lithium vanadium phosphate glass was refined and ground to powders with a particle size of 1 μm or below.

Manufacturing Li_{1.3}Al_{0.3}Ti_{1.7}(PO₄)₃ glass powders:

Ammonium dihydrogen phosphate, titanium dioxide, lithium carbonate, and aluminum oxide were used as raw materials and calcined at 700° C. to remove volatile substances and form glass precursor. The glass precursor was melted at 1450° C., then poured in deionized water, and then quenched into glassy state. Then, the lithium aluminum titanium phosphate glass was refined and ground to powders with a particle size of 1 μm or below.

Manufacturing positive electrode layer:

Then, 0-10 wt % conductive carbon black based on the total weight was coated on the surface of Li₃V₂(PO₄)₃ glass powders and Li_{1.3}Al_{0.3} Ti_{1.7}(PO₄)₃ glass powders and formed green sheets by dry pressing or tape casting.

### [Manufacturing the Negative Electrode Layer]

Manufacturing Li₃V₂(PO₄)₃ glass powders:

Ammonium dihydrogen phosphate, vanadium pentoxide, and lithium carbonate were used as raw materials and calcined at 450° C. to remove volatile substances and form glass precursor. The glass precursor was melted at 1000° C., then poured on a stainless-steel plate, and then quenched into glassy state. Then, the lithium vanadium phosphate glass was refined and ground to powders with a particle size of 1 μm or below.

Manufacturing LiTi₂(PO₄)₃ glass powder:

Ammonium dihydrogen phosphate, titanium dioxide, and lithium carbonate, were used as raw materials and calcined at 700° C. to remove volatile substances and form glass precursor. The glass precursor was melted at 1400° C., then poured in deionized water, and then quenched into glassy state. Then, the lithium titanium phosphate glass was refined and ground to powders with a particle size of 1 μm or below.

Manufacturing Li_{1.3}Al_{0.3} Ti_{1.7}(PO₄)₃ glass powder:

Ammonium dihydrogen phosphate, titanium dioxide, and lithium carbonate, aluminum oxide were used as raw materials and calcined at 700° C. to remove volatile substances and form glass precursor. The glass precursor was melted at 1450° C., then poured in deionized water, and then quenched into glassy state. Then, the lithium aluminum titanium phosphate glass was refined and ground to powders with a particle size of 1 μm or below.

Manufacturing the negative electrode layer:

Then, 0-10 wt % conductive carbon black based on the total weight was coated on the surface of Li₃V₂(PO₄)₃ or LiTi₂(PO₄)₃ glass powders and Li_{1.3}Al_{0.3} Ti_{1.7}(PO₄)₃ glass powders and formed green sheets by dry pressing or tape casting.

### [Manufacturing the LATP Solid Electrolyte Layer]

Manufacturing Li_{1.3}Al_{0.3} Ti_{1.7}(PO₄)₃ glass powders:

Ammonium dihydrogen phosphate, titanium dioxide, lithium carbonate, and aluminum oxide were used as raw materials and calcined at 700° C. to remove volatile substances and form glass precursor. The glass precursor was melted at 1450° C., then poured in deionized water, and then quenched into glassy state. Then, the lithium aluminum titanium phosphate glass was refined and ground to powders with a particle size of 1 μm or below.

Manufacturing the LATP solid electrolyte layer:

Li_{1.3}Al_{0.3} Ti_{1.7}(PO₄)₃ glass powders were formed into green sheets by dry pressing or tape casting, and then were sintered at 700˜1100° C. The resulted Li_{1.3}Al_{0.3} Ti_{1.7}(PO₄)₃ electrolyte substrate had 90% or more crystalline and a remaining glass content lower than 10%.

[Manufacturing the all-Solid-State Battery]

The surface of one side of the sintered LATP solid electrolyte layer above was roughen with 800 grit sandpaper to increase the contact area between composite electrodes (i.e., the electrodes added with electrode powders, electrolyte powders and carbon black, such as the positive electrode layer comprising lithium vanadium phosphate, lithium aluminum titanium phosphate and carbon black above and the negative electrode layer comprising lithium titanium phosphate, lithium aluminum titanium phosphate and carbon black above) and electrolyte. The manufactured sheet of composite positive electrode layer was placed on both roughen sides of the LATP solid electrolyte layer. The composite positive electrode layer and the LATP solid electrolyte layer were pressed with aluminum oxide substrate and aluminum oxide screws, and then placed in a hot press furnace with temperature rising to 300° C. at a heating rate of 1° C./min and keeping the temperature for 2 hours for degreasing. Then, the temperature rose to the glass transition temperature of LATP, LVP, 575° C., at a heating rate of 5° C./min and the temperature was maintained for 4 hours to densify the composite positive electrode layer at the interface of the LATP solid electrolyte layer in form of viscous flow at this stage. Then, the temperature rose to 800° C. at a heating rate of 5° C./min and the temperature was maintained for 4 hours to conduct thermal treatment. The surface of the composite positive electrode at both sides was sputtered with platinum to serve as current collectors. After that, it was placed at the center of an upper battery lid with the side of the above composite positive electrode facing down in a glove box with the atmosphere of argon, and covered by a separator to prevent it from directly contacting the lithium metal. Then, the lithium sheet soaked with liquidous electrolyte was placed on the separator immediately, and a gasket, a spring, and a lower battery lid were added subsequently. A battery sealing machine was used to assemble them into a CR2032 all-solid-state battery.

[Manufacturing an all-Solid-State Battery Pack]

An all-solid-state battery pack was manufactured by:

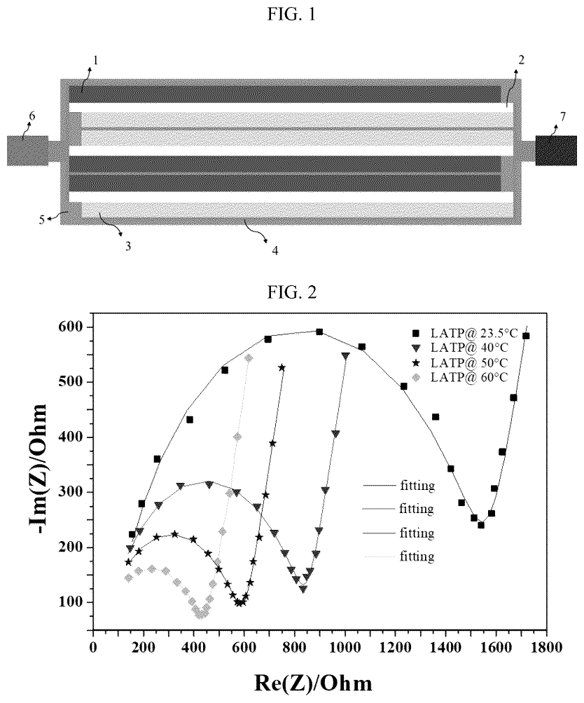

as shown in FIG. 1, interconnecting the all-solid-state batteries with the positive electrode layer 1, the solid electrolyte layer 2, and the negative electrode layer 3 in parallel, and collecting to positive electrode 6 and negative electrode 7 at both ends to form an all-solid-state battery pack 5. Further, besides the platinum above, the metal current collector layer 4 may be selected from at least one of a group consisting of nickel, copper, and silver. It should be noted that CR2032 is merely an analysis sample manufactured for conducting single cell analysis. An actual product is the stacked all-solid-state battery pack shown in FIG. 1. The all-solid-state battery pack was manufactured by: placing the aforementioned positive electrode green body on the sintered electrolyte sheet and followed a thermal treatment at 700˜1100° C.; placing the aforementioned negative electrode green body on the other side of the heat-treated electrolyte sheet and followed another thermal treatment at 700˜1100° C., or use metal lithium sheet as the negative electrode. Then, the steps of the method above were repeated to manufacture a plurality of the single all-solid-state batteries. In the end, the plurality of all-solid-state batteries were connected by a metal electrode made of one of nickel, copper, silver, and platinum as the current collector layer in parallel to form the all-solid-state battery pack.

### [Performance Evaluation]

[Measuring the Ionic Conductivity of the Solid Electrolyte Manufactured by Li_{1.3}Al_{0.3} Ti_{1.7}(PO₄)₃ Glass Powders]

The Li_{1.3}Al_{0.3} Ti_{1.7}(PO₄)₃ glass powders were processed to form green body with a diameter of 8 mm and a thickness of 1 mm by dry pressing. The green body was sintered at 1000° C. in air until it formed a sample with a density of 95% or more and a level of crystallinity of 90% or more. The both sides of the sintered sample to be tested were sputtered with platinum electrodes as blocking electrodes. Then, the sample with a diameter of 7 mm and a thickness of 0.55 mm was analyzed with electrochemical (AC) impedance spectroscopy. FIG. 2 shows the impedance spectroscopy of solid electrolyte of the sample to be tested by AC impedance analysis with the potentiostat (Bio-Logic, SP-150e, France) at 23.5° C., 40° C., 50° C. and 60° C. The fitting of impedance spectroscopy result was performed with the software (EC-lab, Bio-Logic, France) to obtain the impedance values of the solid electrolyte layer and calculate the ionic conductivity thereof with the equation (1), as shown in Table 1. Accordingly, the solid electrolyte manufactured by Li_{1.3}Al_{0.3} Ti_{1.7}(PO₄)₃ glass powders exhibited excellent ionic conductivity. Therefore, the all-solid-state battery using the aforementioned solid electrolyte may exhibit excellent conductivity and electrochemical properties.

$$Equation ( 1 )$$

$$ionic conductivity ( S / cm ) = thickness of sample ( cm ) / ( cross - sectional area of sample ( {cm}^{2} ) \times total resistence ( ohm , Ω ) )$$

TABLE 1

| Temperature (° C.) | ionic conductivity (S/cm) |
|---|---|
| 23.5 | 8.33 × 10⁻⁴ |
| 40 | 1.54 × 10⁻³ |
| 50 | 2.18 × 10⁻³ |
| 60 | 2.94 × 10⁻³ |

[Measuring the Electronic Conductivity of the Electrodes, the Ionic Conductivity of the Solid Electrolyte Manufactured by Li₃V₂(PO₄)₃ Glass Powders]

The Li₃V₂(PO₄)₃ glass powders were processed to form green body with a diameter of 8 mm and a thickness of 1 mm by dry pressing. The green body was sintered at 800° C. in the atmosphere of nitrogen. The both sides of the sintered sample to be tested were sputtered with platinum electrodes as blocking electrodes. The sample had a diameter of 7 mm and a thickness of 0.55 mm. The DC polarization analysis of the sample to be tested was performed with the potentiostat (Bio-Logic, SP-150e, France) and a constant potential of 5 mV was applied for 10 minutes. With DC polarization, the electronic conductivity of the pure phase LVP electrode was calculated with the equation (2). The result is shown in Table 2.

$$Equation ( 2 )$$

$$electronic conductivity ( S / cm ) = ( current value at 10 minutes ( amp , A ) \times thickness of sample ( cm ) ) / ( voltage of constant potential ( volt , V ) \times cross - sectional area of sample ( {cm}^{2} ) )$$

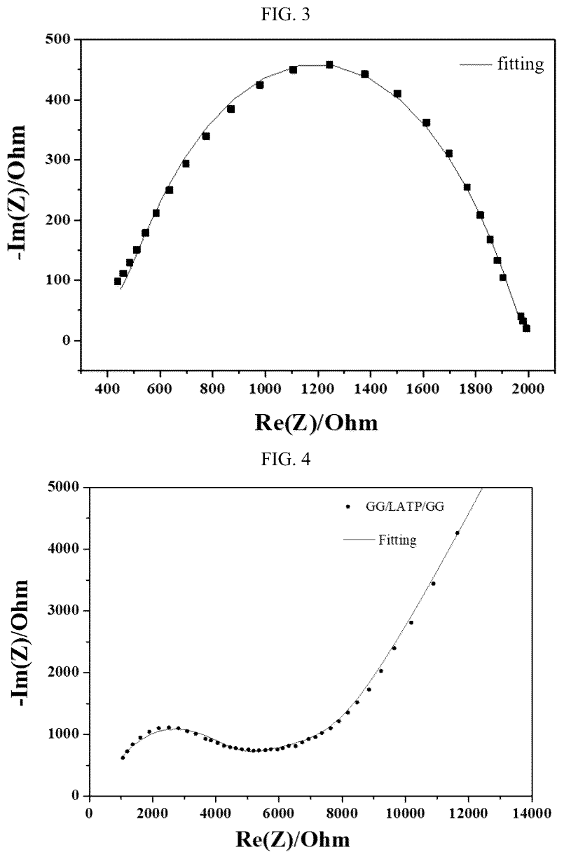

The Li₃V₂(PO₄)₃ glass powders were processed to form green body with a diameter of 8 mm and a thickness of 1 mm by dry pressing. The green body was sintered at 800° C. in the atmosphere of nitrogen. The both sides of the sintered sample to be tested were sputtered with platinum electrodes as blocking electrodes. The sample had a diameter of 7 mm and a thickness of 0.55 mm. The AC impedance analysis of the sample to be tested was performed with the potentiostat (Bio-Logic, SP-150e, France) and the impedance spectroscopy is shown in FIG. 3. The fitting of impedance spectroscopy result was performed with the software (EC-lab, Bio-Logic, France) to obtain the impedance values of the solid electrolyte layer and calculate the ionic conductivity thereof with the equation (3), as shown in Table 2.

TABLE 2

| | Electronic | Ionic |
|---|---|---|
| | conductivity | conductivity |
| | (S/cm) | (S/cm) |
| LVP-10 wt % conductive carbon | 1.8 × 10⁻⁵ | 1.105 × 10⁻⁴ |
| black coated | | |
| Composite positive electrode | 1.755 × 10⁻⁴ | 5.867 × 10⁻⁴ |
| (comprising LVP coated with | | |
| conductive carbon black, LATP, | | |
| carbon black additionally added) | | |

Accordingly, the electrodes manufactured by Li₃V₂(PO₄)₃ glass powders exhibited excellent electronic conductivity and the solid electrolyte manufactured by Li₃V₂(PO₄)₃ glass powders exhibited excellent ionic conductivity. Therefore, the all-solid-state battery with electrode layers, solid electrolyte layer manufactured with it may exhibit excellent conductivity and electrochemical properties.

$$Equation ( 3 )$$

$$ionic conductivity ( S / cm ) = thickness of sample ( cm ) / ( cross - sectional area of sample ( {cm}^{2} ) \times total resistance ( ohm , Ω ) )$$

[Measuring the Resistance of the Interface Between the all-Solid-State Electrolyte Layer and the Positive and Negative Electrode Layers]

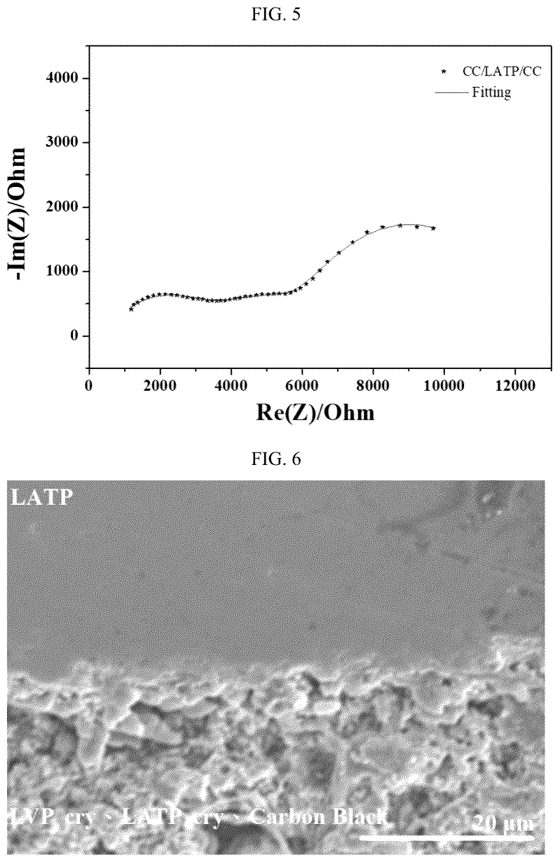

First, the electrolyte sheets were applied to the both sides of the electrode layers, and then sintered to form a sandwich battery. The both sides of the sandwich battery sample to be tested were sputtered with platinum electrodes as blocking electrodes subsequently. The AC impedance analysis was performed with the potentiostat (Bio-Logic, SP-150e, France). The fitting of impedance spectroscopy result was performed with the software (EC-lab, Bio-Logic, France) to obtain the resistance values of the solid electrolyte layer, the interface between the solid electrolyte layer and electrode layers. The results are shown in FIG. 4, FIG. 5, and Table 3. The positive and negative electrode layers (GG) and the solid electrolyte layer (GG/LATP/GG) manufactured with glassy LVP as raw materials had lower resistance of interface than that of the positive and negative electrode layers (CC) and the solid electrolyte layer (CC/LATP/CC) manufactured with the crystalized powders of crystalline LVP glass powders thermally treated with 700° C. as raw materials.

TABLE 3

| | LATP | LATP grain | LVP | LVP |
|---|---|---|---|---|
| | grain | boundary | CT | CT |
| | (Ohm) | (Ohm) | (Ohm) | (Ohm) |
| CC/LATP/CC | 350.9 | 2136 | 6550 | 3412 |
| GG/LATP/GG | 229 | 3815 | 625.2 | 371 |

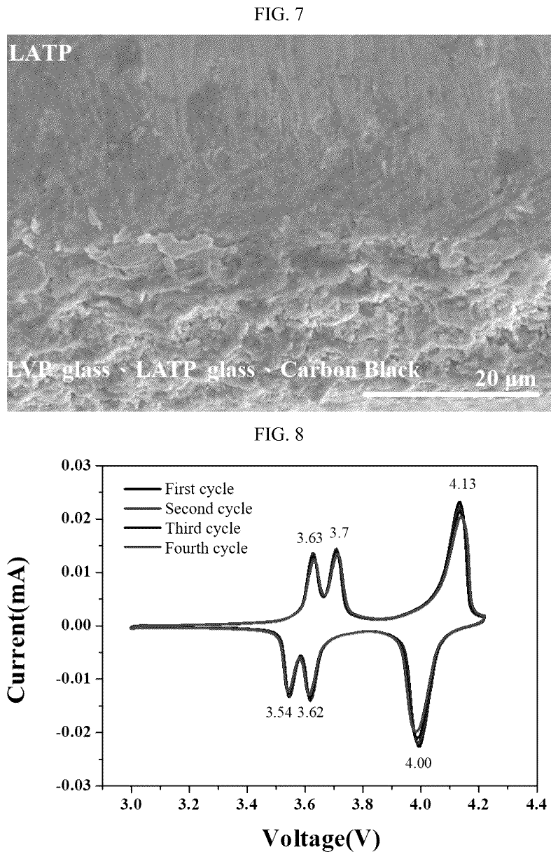

Further, the microstructure images of the contacting interface between the crystalline and glassy electrode layers and the solid electrolyte layer were obtained with the scanning electron microscope (Hitachi, SU-5000, Japan) with the parameters setting: a voltage of electron beam of 10 kV, a working distance of 10.5 mm, a magnification of 2000 folds. If the microstructure of the contacting interface shows no pore, it represents that the binding strength at the contacting interface is strong. According to the microstructure image of the contacting interface between the crystalline electrode layers and the solid electrolyte layer shown in FIG. 6, and the microstructure image of the contacting interface between the glassy electrode layers and the solid electrolyte layer shown in FIG. 7, it can be found that the binding strength of the contacting interface between the electrode layers manufactured with glassy LVP as raw material and the solid electrolyte layer is greater than that of the contacting interface between the electrode layers manufactured with crystalline LVP as raw material and the solid electrolyte layer, which verified that the contact of the interface between the glassy electrode layers and the solid electrolyte layer is better than that of the interface between the crystalline electrode layers and the solid electrolyte layer. Therefore, the present disclosure uses phosphates having a NASICON type structure as the positive and negative electrode layers and the solid electrolyte layer of the all-solid-state battery, which can reduce adverse side reaction during sintering, strengthen the contact of the interface between the positive and negative electrode layers and the solid electrolyte layer, and improve all electrochemical properties of the battery.

[Performance Test of the all-Solid-State Battery Pack]

The electrochemical stability window of the all-solid-state battery pack was measured with the potentiostat (Bio-Logic, SP-150e, France) at a scan speed of 1 mV/s, and a scan range of 2.5V-5.5V. The result is shown in FIG. 8. Based on the result, it could be known that the all-solid-state battery pack of the present disclosure still exhibited good electrical properties and cycling stability after 4 cycles, which verified that it has excellent charging and discharging cycling ability.

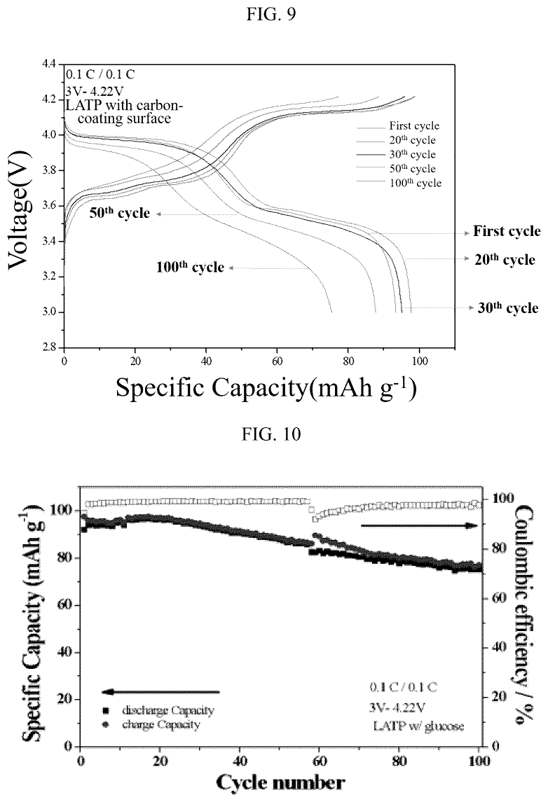

Also, the cycling test of charging and discharging for the all-solid-state battery pack was performed with 100 cycles. The all-solid-state battery pack was placed in a programmable multi-channel battery cycling machine (Neware, CT-4008T-5V₅₀MA-164-U, China) and underwent charging and discharging cycling with constant current at room temperature at a rate of 0.1C in a voltage range of 3.0V-4.22V. The changes in charging and discharging voltage plateau, cycling stability, and specific capacity were observed to test the cycling stability of the batteries, the cycling efficacy of the all-solid-state batteries, and reliability of the product. As shown in FIG. 9, FIG. 10, and Table 4, it can be known that the battery exhibits excellent capacity and charging and discharging cycling ability. According to the examples above, it can be proven that the all-solid-state battery, the all-solid-state battery pack using thereof, and the methods of manufacturing thereof of the present disclosure have effects including greater safety in use, being non-flammable, excellent charging and discharging efficacy and capacity maintained after multiple charging and discharging cycles, having good stability, excellent electrochemical properties of battery and being eco-friendly.

TABLE 4

| | First Capacity | 100th Capacity | Capacity Retention |
|---|---|---|---|
| | (mAh g⁻¹) | (mAh g⁻¹) | (%) |
| 3 V-4.22 V | 92.01 | 75.25 | 81.79 |

What is claimed is:

1. An all-solid-state battery, comprising:
a positive electrode layer containing a phosphate having a NASICON type structure and conductive materials;
a negative electrode layer containing a phosphate having a NASICON type structure and conductive materials; and
a solid electrolyte layer containing a phosphate having a NASICON type structure.

2. The all-solid-state battery of claim 1, wherein the positive electrode layer further contains an active material: lithium vanadium phosphate (Li₃V₂(PO₄)₃).

3. The all-solid-state battery of claim 1, wherein the negative electrode layer further contains active materials including lithium vanadium phosphate (Li₃V₂(PO₄)₃), lithium titanium phosphate (LiTi₂(PO₄)₃), or metal lithium.

4. The all-solid-state battery of claim 1, wherein the conductive materials contained in the positive electrode layer and the negative electrode layer include conductive carbon black, activated carbon, or graphite and have an amount of 0.1-10 wt % of the positive electrode layer, and 0.1-10 wt % of the negative electrode layer.

5. The all-solid-state battery of claim 1, wherein the phosphates having a NASICON type structure of the positive electrode layer, the negative electrode layer, and the solid electrolyte layer are identical materials.

6. The all-solid-state battery of claim 5, wherein the identical materials are Li₍₁₊ₓ₎M1₍ₓ₎M2₍₂₋ₓ₎(M3O₄)₃, wherein M1 is Al, V, or Cr elements, M2 is Ti, or Ge, M3 is Si, or P, and x is 0-0.5.

7. A method of manufacturing the all-solid-state battery of claim 1, comprising:
Step 1: preparing a positive electrode green body containing a phosphate having a NASICON type structure;
Step 2: preparing a negative electrode green body containing a phosphate having a NASICON type structure or a metal lithium;
Step 3: preparing the solid electrolyte layer containing a phosphate having a NASICON type structure, comprising:
Step 3.1: melting phosphates raw materials having a NASICON type structure at high temperatures, then being quenched into a glassy state, then refined and ground to powders;
Step 3.2: preparing the powders into a green body;
Step 3.3: sintering the green body at 700-1100° C. to an electrolyte sheet having a density of 95% or more;
Step 3.4: placing the positive electrode green body on a sintered electrolyte sheet, and thermally treating them at 700-1100° C.;
Step 3.5: placing the negative electrode green body on the other side of the electrolyte sheet treated with step 3.4, and thermally treating them at 700-1100° C., or using metal lithium sheet as negative electrode.

8. The method of manufacturing of claim 7, wherein the sintered phosphates powders having a NASICON type structure in step 3.3 has 90% or more crystalline, with a remaining glass content lower than 10%.

9. An all-solid-state battery pack, comprising:
a metal current collector layer selected from at least one of a group consisting of nickel, copper, silver, and platinum;
a plurality of the all-solid-state batteries of claim 1.

10. A method of manufacturing the all-solid-state battery pack of claim 9, comprising:
interconnecting the plurality of the all-solid-state batteries of claim 1 in parallel with the metal current collector layer, and collecting to a positive electrode and a negative electrode at both ends to form the all-solid-state battery pack.
